(19) United States
(12) Patent Application Publication
(10) Pub. No.: US 2016/0292447 A1
(43) Pub. Date: Oct. 6, 2016

(54) MULTI-LAYERED ENCRYPTION

(71) Applicant: Lawlitt Life Solutions, LLC, Austin, TX (US)

(72) Inventors: Jonathan Andrew LAWRENCE, Clovis, CA (US); Kim Mullen LITTLE, Austin, TX (US)

(21) Appl. No.: 15/092,461

(22) Filed: Apr. 6, 2016

Related U.S. Application Data
(60) Provisional application No. 62/143,616, filed on Apr. 6, 2015.

(51) Int. Cl. G06F 21/62; H04L 9/14; G06F 21/60

(52) U.S. Cl. CPC G06F 21/6218; G06F 21/602; H04L 9/14

(57) ABSTRACT

Techniques are described herein for encrypting data using a multi-layered encryption process. A service may encrypt data with first and second data keys and store the encrypted data. The system may encrypt the first data key with a first user key and the second data key with a second user key and store the data keys and the user keys in separate locations. The service may associate the user keys with a client device. In one aspect, the user keys may each include and be stored as a set of system keys and a set of ordered pairs of numeric values, with each ordered pair containing a start value and a read length value associated with one of the set of system keys. The service may assemble each user key by combining data from each of the system keys according to the associated ordered pair.

### CROSS REFERENCE TO RELATED APPLICATIONS

This application claims benefit under 35 U.S.C. §119(e) of Provisional U.S. Patent Application No. 62/143,616, filed Apr. 6, 2015, the contents of which is incorporated herein by reference in its entirety.

### TECHNICAL FIELD

The present disclosure is related to the field of data security and encryption.

### BACKGROUND

Data security is becoming increasingly important. More data and particularly more sensitive and private data is being generated, such as private health information, private financial information, personal identification information, and other personal information including images, videos, documents, etc. Alongside these increases in data generation are increases in processing and computational ability of hardware and software technologies to break known data security and encryption techniques. With recent jumps in computational power of devices to crack known encryption techniques, existing technologies may not properly defend against such attacks, including Man in the Middle (MiTM) attacks, spoofing, and the like, very far into the future. Additionally, due in part to these increases, any weakness in a data storage/security system now has a greater chance of being identified and exploited.

### SUMMARY

Methods and systems for receiving, storing, and managing access to data are described herein. A data security system may encrypt and securely store data associated with an account or client device, in one or more databases or other physical or virtual data storage facility or structure. The data security system, as described herein, may include one or more aspects described below. In one aspect, a client device may register with a data service (e.g., a web service) by providing various information to the service, including login credentials and one or more unique identifiers or signatures, such as part of a device identification (ID). The unique identifiers(s)/device ID may include a graphic identifier unique to the device and, upon registration, may be associated with a user account. In some aspects, the unique graphic identifier may include two graphic elements, for example, generated by a graphic card or other component of the device. The two graphic elements may include a text graphic and a shape and/or color graphic (object graphic). The two graphic elements may each be converted to numeric values (e.g., first converted to binary, then hashed to numeric) and then combined to form a single unique graphic identifier. Due to the fact that the graphic card of each device will produce a slightly different version of the same graphic element, reproduction is extremely improbable.

Upon receiving the device ID and login credential information, the data service may authenticate the client device. The client device may then submit data to be stored by the data service. Upon receiving the data, the data service may encrypt the data and store the data in a location associated with the client device/user account. In one aspect, encrypting the data may include encrypting the data using a first encryption process according to a first key (e.g., AES_256 with a 256 byte key); compressing the encrypted data (e.g., using ZLIB compression techniques), and subsequently encrypting the encrypted compressed data again using a second encryption process according to a second key (e.g., which may also include using an AES_256 encryption scheme associated with a second 256 byte key). The encrypted data may be stored in a database, for example, such as a separate data database. The first and second keys may then be further encrypted and stored, such as in a key database, which may be part of or separate from the data database.

In some aspects, encrypting the first and second keys may be performed according to a third and/or fourth encryption process using two additional keys: a first user key and a second user key. In some aspects these keys may be associated with the client device/user account, and stored in a separate location, such as in a user database that is separate from the key database and the data database. Storing the keys in separate locations may, for example, further isolate the different keys and enhance security/make it more difficult for another party to obtain keys and/or gain access to a user's data.

In one aspect, the first and second user keys may each be further associated with six system keys. The first and second user keys may be assembled from various portions of the six system keys. The first and second user keys may each include six ordered pairs, with each ordered pair containing a start value and a read length value associated with one of the six system keys. In some cases, the first and second user keys may each comprise the six ordered pairs without any additional information, thus making the keys more difficult to decipher, for example, by an unwanted party to the system. The first and second user keys may be assembled from the six system keys according to the ordered pairs. In some aspects, the first and second user keys may share or be associated with a single set of six or other number of systems keys from which to assemble the keys, and in other cases, each of the first and second user keys may be associated with a separate set of system keys.

Once the data is received and encrypted by the data service, the data service may store the encrypted data, store the corresponding keys, and associate the keys and the data with the client device/user account. The client device, or another device associated with the user account, may subsequently access the data at any time. Upon authentication of the client device, the data service may receive a request to view/retrieve data from the client device. In some aspects, each file or other data container/organizational unit of data stored in/by the data service may be associated with its own two data keys, and its own two user keys. After authentication, the client device may specify which data file/storage container is requested for retrieval or viewing. Upon receipt of the data file retrieval request, the data service may, in the background and not necessitating any other input from the client device, obtain the two user keys. Obtaining the two user keys may include accessing the user keys (e.g., the six ordered pairs for each key) from the user database, and assembling the two user keys from the six system keys, according to the ordered pairs. The data service may, and in some cases concurrently with assembling the two user keys, access the encrypted data from the data database and may access the two data keys associated with the data from the key database. Upon assembling the two user keys, the data service may then decrypt the two data keys using the two user keys. The data service may then decrypt the user data, by for example, using the second data key to decrypt the first layer of encryption, to produce the compressed encrypted user data. The data service may subsequently de-compress or expand the encrypted data, and decrypt the un-compressed encrypted data using the first data key. The unencrypted data may then be displayed/viewed by the client device through the data service.

In this way, data may be stored and accessed in an extremely secure manner, for example, by limiting the amount of security information that is communicated to the client device, such as over public networks, and by eliminating any plain text communications between the databases and the data service. Additionally, by using the device ID in the first instance to authenticate the device, the entire system is made more secure by thwarting spoofing type attacks.

### BRIEF DESCRIPTION OF THE DRAWINGS

FIG. 1 is a block diagram illustrating an example data storage system.

FIG. 2A illustrates an example process for registering/authenticating a client device with a data service.

FIG. 2B illustrates another example process for registering/authenticating a client device with a data service.

FIG. 3 illustrates an example process for generating a unique graphic identifier.

FIG. 4 is a block diagram illustrating an example of a device ID for registering/authenticating a client device with a data service.

FIG. 5 illustrates an example process for submitting, encrypting, and storing data with a data service.

FIG. 6 illustrates an example process for generating one or more user encryption keys.

FIG. 7 is a block diagram illustrating an example of double encrypted and compressed data generated by the process of FIG. 5.

FIG. 8 illustrates an example data database configured to store user data.

FIG. 9 illustrates an example process for retrieving data securely stored by the process of FIG. 10, by a data service.

FIG. 10 illustrates an example process for decrypting encrypted data using two user keys and 2 data keys.

FIG. 11 illustrates an example computing system that may be configured to implement one or more of the processes described herein.

### DETAILED DESCRIPTION OF ILLUSTRATIVE EMBODIMENTS

A new and secure data storage system is described herein. In one aspect, a unique graphic identifier or a unique device ID may be used to register/authenticate a client device, for example, with a data service. In some aspects, a multi-key encryption system or topology may be implemented by the data service to securely store data received from the client device. A three layer encryption process may additionally or alternatively be implemented to securely store user data. One or more of these systems may be operative independent of the other aspects, or may be combined in various ways to yield a more secure data storage service.

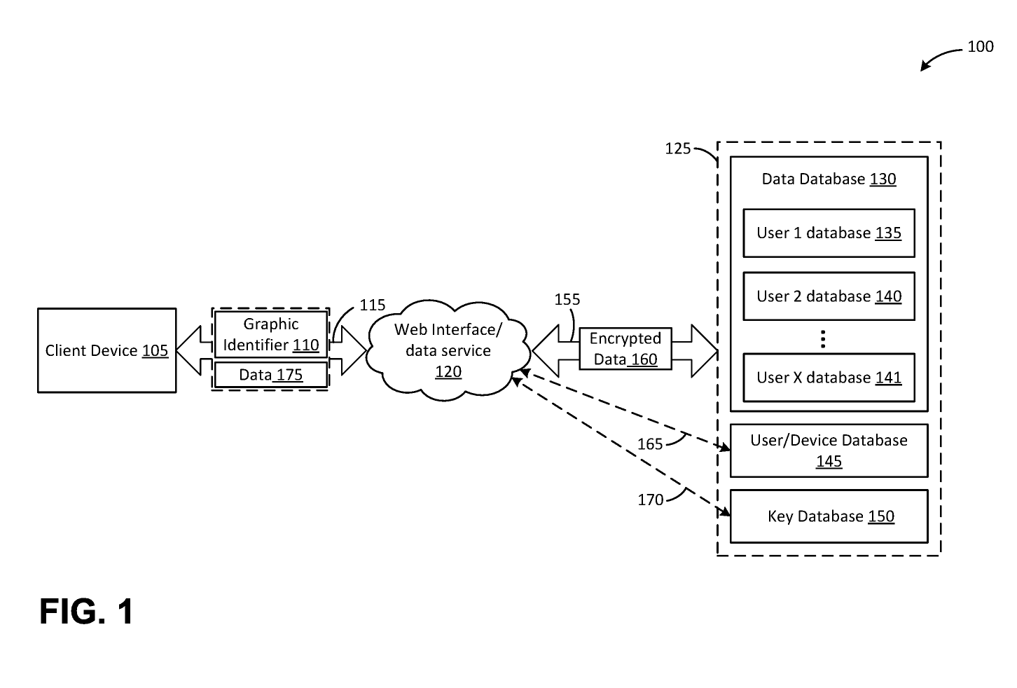

FIG. 1 is a block diagram illustrating an example system 100 for securely storing and managing user data. The system 100 may include a client device 105 capable of communicating with a web interface/data service 120 via a communication link 115. The web interface 120 may be capable of communicating with one or more databases 125 via communication link 155. The database(s) 125 may include a data database 130, a user/device database 145, and/or a key database 150. In other scenarios, the data database 130, the user/device database 145, and the key database 150 may be separate databases, for example, to further isolate user/client device information, encryption information, and data. In the example illustrated, the web interface 120 may communicate separately with the user/device database 145 via communication link 165, and with key database 150 via communication link 170.

The client device 105 may include any of a mobile device, tablet, laptop, personal computer, other computing device, etc. The web interface/data service 120 may be a web-based application, including instructions executable by one or more processors, computing devices, servers, etc. The client device 105 may communicate with the web interface 120 via link 115, for example, using any of a variety of wireless communication protocols or technologies (LTE, WiFi, WiMAX, other 802.11 or 802.16 standards, etc.) or via one or more wired communication links. The web interface 120 may communicate with the database 125, the data database 130, the user/device database 145, and/or the key database 150 via similar or different communication technologies via links 155, 165, and 170. In some examples, the web interface 120, the data database 130, the user/device database 145, and/or the key database 150 may be located in different physical locations, may be implemented on different physical components, and/or may be associated with different virtual machines or instances.

The data database 130 may be configured to store user data, for example that is encrypted. The data database 130 may store client or user data in various separate stores 135, 140, for example that each may contain any number of tables or files. In this way, user information may be kept separate, and hence be more secure, easier to access, enabling larger storage files, etc. The user/device database 145 may store user information, such as account information, device information associated with an account, user encryption keys, and other similar information. The key database 150 may store data encryption keys for encrypting and decrypting data stored in the data database 130.

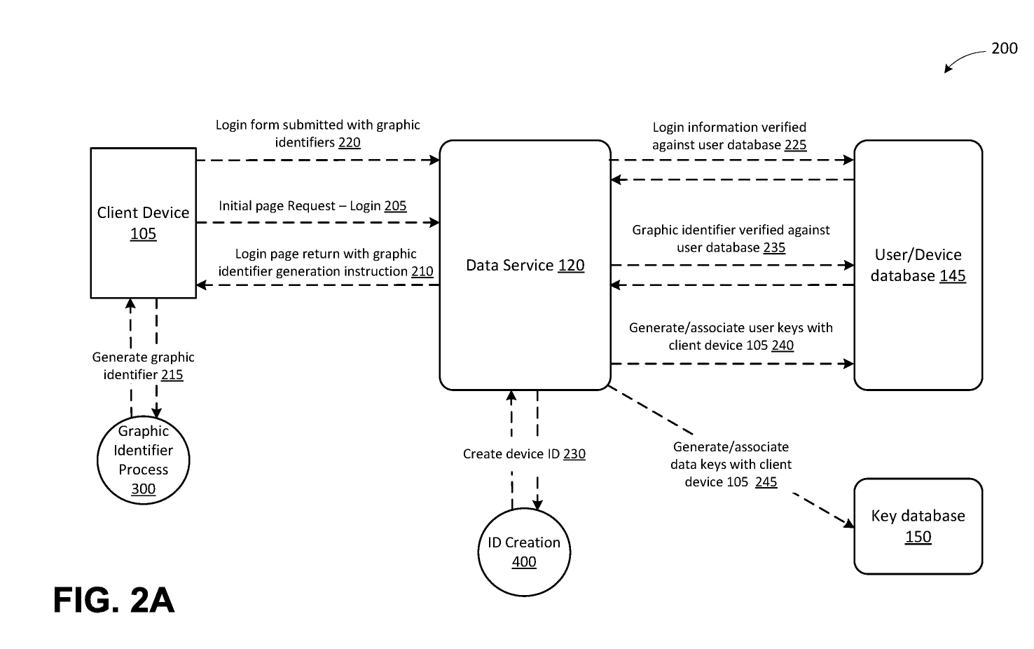

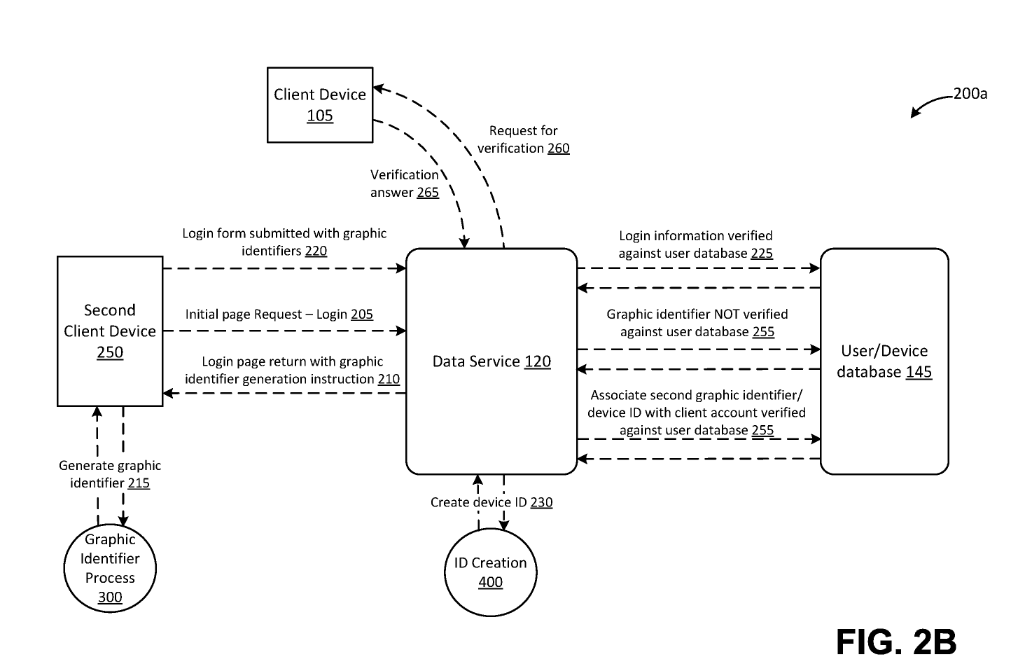

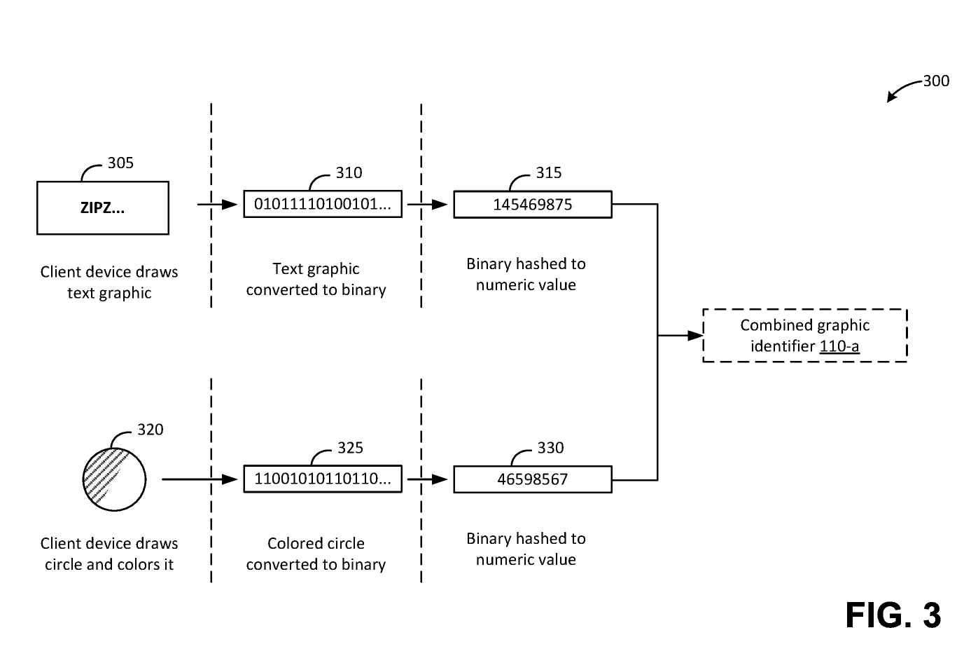

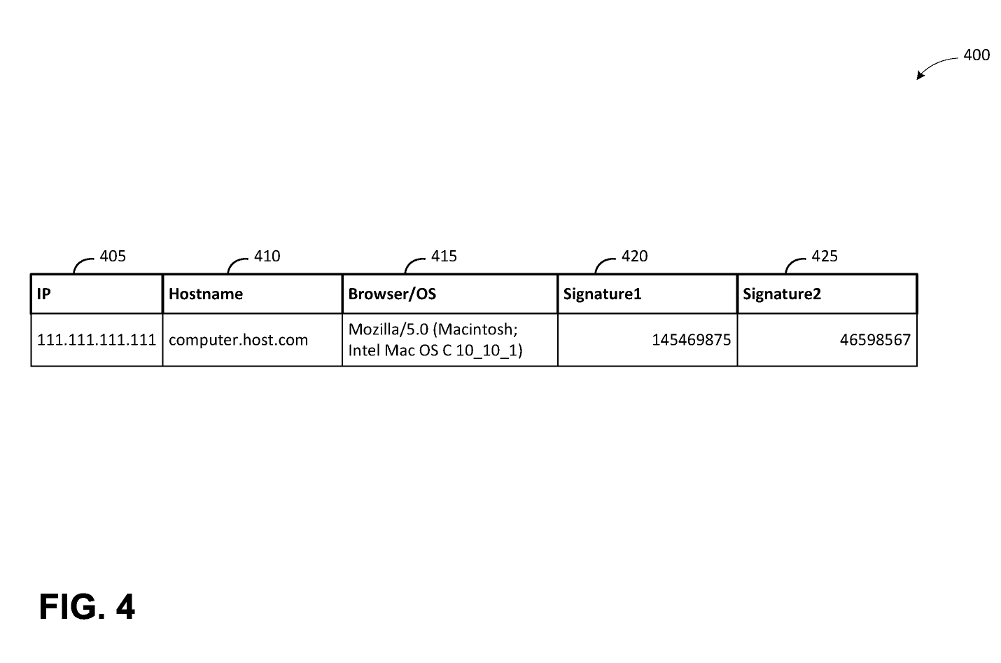

The web interface/data service 120 may manage the data database 130 and storage of user data thereon using one or more encryption/decryption processes, for example associated with keys stored in the key database 150 and/or user/device database 145. The web interface 120 may receive login credential information, for example, including a username and password, and a graphic identifier or signature 110 from the client device 105. If the client device 105 is new to the data service 120, the client device 105 may register with the web interface 120 by providing new device or login information and a graphic identifier 110 to the web interface 120. The login information may include a user name, a password, and any other identification information, for example requested by the web service 120 upon receiving a request to register from the client device 105. The graphic identifier 110 may include a unique identifier of the client device 105, for example including multiple graphic identifiers. An example of the graphic identifier 110 will be described in greater detail below with reference to FIGS. 3 and 4. Upon receiving login/credential information and the graphic identifier 110, this information may be associated with the client device 105/account and stored in the user/device database 145. The details of an example registration process will be described in greater detail in reference to FIGS. 2A and 2B. After registering, the client device 105 may subsequently access the data service 120. If the client device 105 has already registered with the data service 120, then upon submitting the login information/graphic identifier 110, the web interface 120 may access information associated with the device 105 and verify that the login information matches the information stored for the client device 105/associated user account. Upon verification, the client device 105 may be authenticated and be granted access to the data service 120.

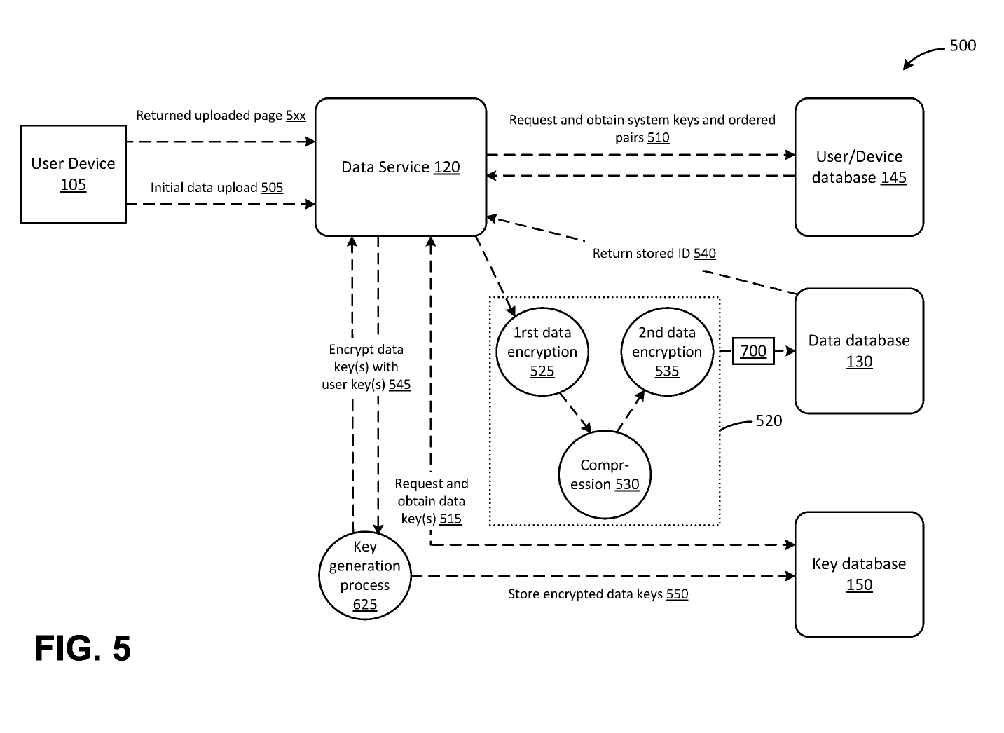

After registration/authentication, the data service 120 may receive, encrypt and securely store data 175 received from the client device 105 in the data database 130. The data service 120 may encrypt the data 175 to produce encrypted data 160 and store the associated data encryption key(s) in the key database 150. In some aspects, only encrypted data 160 is communicated between data service 120 and the data database 130 to minimize any breach in security of the data. In some aspects, the data structure or file may be stored in a user specific database 135, 140, for example, that is linked to the client device 105 and/or an account associated with client device 105 (an account may be associated with multiple devices according to multiple graphic identifiers/device IDs). In some cases, each file or data structure may be stored in its own table. The data service 120 may communicate with the data database 130 to identify location/file information of the stored encrypted data, for example, to be associated with a client device 105/account in the user database 160. In other cases, the file location may be stored in the data database 130 itself, or in another location. In some aspects, the data service 120 may further encrypt the data key(s) associated with the data and store the second layer of keys, which may be referred to as user key(s), for example, in the key database 150, the user/device database 145, or in a separate location (not shown). An example process for encrypting the data will be described in greater detail below in reference to FIGS. 5-8. In some aspects, the data service 120 may associate different keys with different files or other data structures, as indicated by the client device 105.

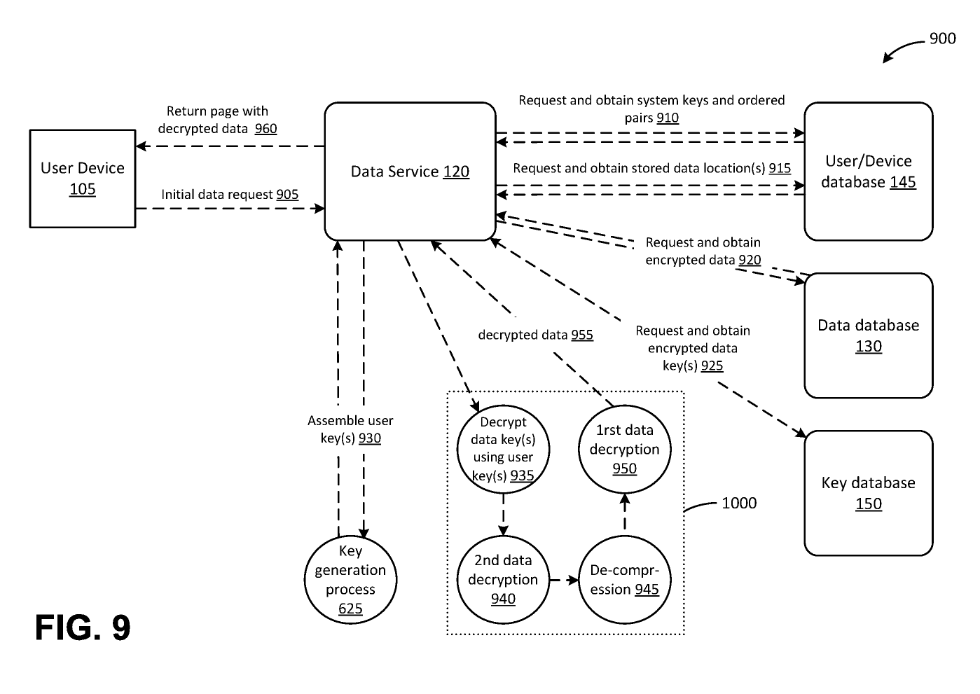

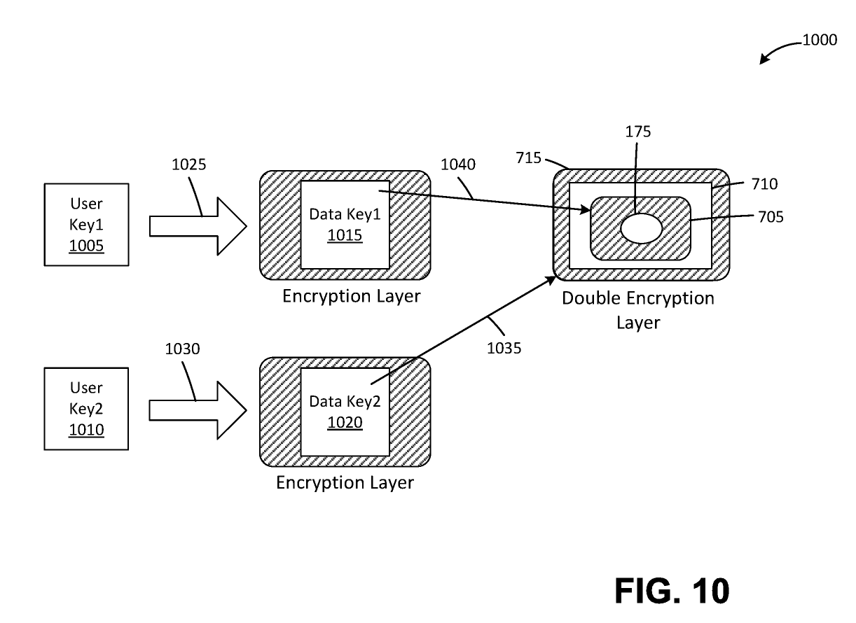

In some aspects, the data service 120, after authenticating the client device 105 via communications with the user/device database 145, may receive a request to retrieve or access data managed by the data service 120 and stored in the data database 130. In response to the request, the data service 120 may access/retrieve the data encryption keys from the key database 150. Concurrently, or at a different time, the data service 120 may also access or retrieve the encrypted indicated file or data structure, for example, stored in a user database 135, 140. In aspects where the data keys have also been encrypted, the data service 120 may access, retrieve, and/or assemble the user keys from the user/device database 145 and use the user keys to decrypt the data keys. The data service 120 may then decrypt the user data 160 using the data encryption keys accessed from the key database 150. In this way, all decryption may be performed by the data service 120, thus separating and potentially avoiding any compromising of the data or keys themselves. In some aspects, the decryption process may be performed while the data is being streamed from the database server 145, to further add security by not having to store the data temporarily. Example processes for decrypting stored data will be described in greater detail below in reference to FIGS. 9 and 10. Each aspect of the data service/data management system will be described in further detail below.

FIG. 2A depicts an example process 200 for registering and/or authenticating a client device 105 with the data service 120. The data service 120 may communicate with the user/device database 145 and the key database 150, for example via any of links 155, 165, or 170 described above. Process 200 may begin by the client device 105 accessing an initial or login page of the data service 120 at 205. The data service 120 may, in response, transmit back to the client device 105 signature, e.g., graphic identifier 110, generation instructions at 210. The instructions 210 may include instructions for generating one or more pre-set or variable graphic components of a graphic identifier 110. The instructions 210 may specify text, shapes, shading, color, line weights, process steps in generating a graphic identifier, and so on. In some cases, the instructions may include size or resolution, color, or other such parameters to define a graphic identifier 110 or element thereof. In some aspects, the instructions 210 sent to the client device 105 may give some level of freedom, for example, for client device 105 or a graphics generation component of the client device 105 to interpret and carry out the instructions. For example, the instructions 210 may include instructions to draw a circle and color the interior of the circle green or to draw a square and color the interior of the square blue. The precise way in which each client device 105 or graphics generation component of each client device 105 interprets these instructions and then generates the requested graphic identifier or element thereof, may differ. As an example, the differences may include one or more differences in the shade of the color used, size of the object, properties of the outer perimeter of the object, and so on. These differences in instruction interpretation may add, on top of different details in the generation of the graphic identifier, to the uniqueness of the graphic identifier.

The client device 105, in response to receiving instructions 210, may generate a graphic identifier at 215, for example, according to graphic identifier generation process 300, which will be described in greater detail below in reference to FIG. 3. In some aspects, the graphic identifier 110 may be generated by a component, such as a graphics card, of the client device 105 in the background without requiring or requesting any additional user input. In some cases, the client device 105 may provide an indication, for example via a user interface, that the unique graphic identifier request has been received, that the unique graphic identifier has been generated, etc. In other aspects, the act of receiving the instructions to generate the graphic identifier, generating the identifier, and/or sending the identifier may cause no change to the user interface provided by the client device 105. Upon generation of the unique graphic identifier, the client device 105 may submit login information and the graphic identifier(s) at 220. The login information may include a username and password, and/or other similar types of identification information. For example, when the client device 105 is first registering with the data service 120, other information, such as personal information, address information, contact information, other communication addresses, phone numbers, etc., may be requested and submitted by the client device 105. In some aspects, communications between the client device 105 and the web service 120 may be encrypted using Secure Sockets Layer (SSL) encryption. The data service 120 may, in response to receiving the graphic identifier(s) and login information at 220, generate a device ID 400 at operation 230, including the graphic identifier(s) and other device information. An example device ID 400 will be described in greater detail below in reference to FIG. 4.

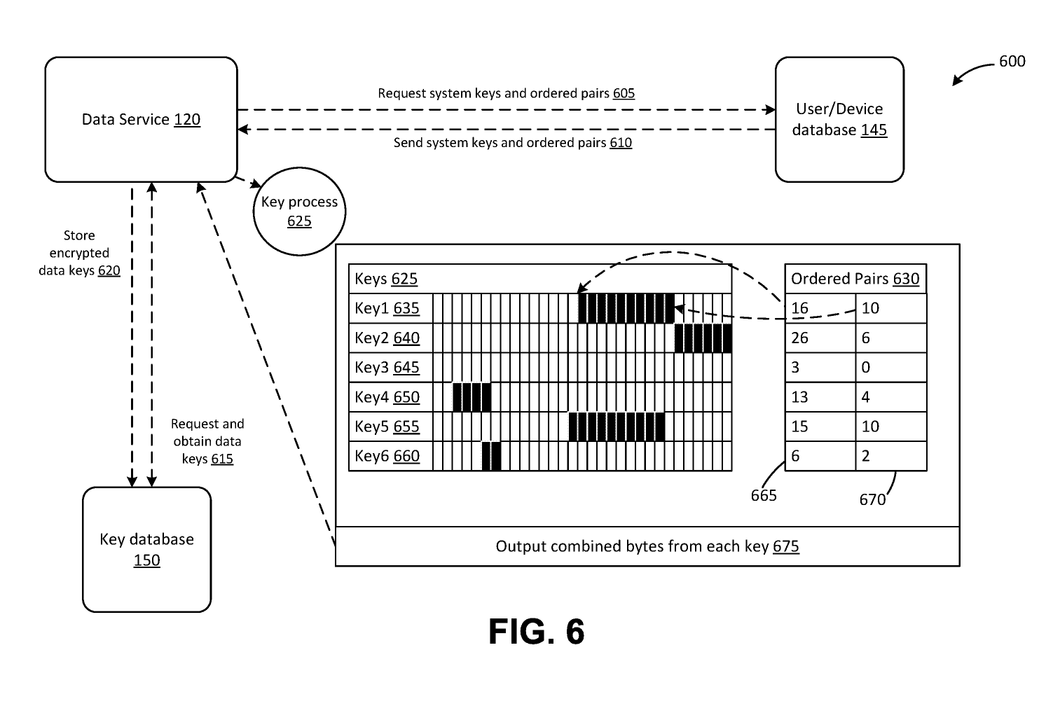

In the first-time registration example, the identification information and/or device ID may be stored, for example, in the user/device database 145 under a new account for the client device 105 or simply associated with the client device 105. Upon registration, the client device 105 may now be associated with an account, and be granted access to the data service 120, for example, including the ability to save and securely store data for later retrieval. The data service 120 may also generate or associate one or more user keys (e.g., including system keys, which may be randomly generated by the data service 120, and one or more ordered pairs) with the client device 105/account and store the user key(s) in the user/device database 145 at 240. The process for assembling or generating user keys from the systems keys and ordered pairs will be described in greater detail below in reference to FIG. 6. Also upon registration, or when data is uploaded to be stored using the data service 120, the data service 120 may generate or associate one or more data keys for encrypting the data for storage in the data database 130 and store the data keys in the key database 150 at 245. In some aspects the data service 120 may generate the user key(s) and/or the data key(s) and store the keys in the respective databases, or may instruct the databases 145, 150 to generate and store the encryption keys. In some implementations, some or all user information, including client device 105 information, login information, graphic identifier(s), and/or a device ID may be encrypted before being stored in the user/device database 145. Each device ID may be associated with an encryption key, such that upon verifying that the device ID is stored in the user/device database 145, the encryption key may be provided to the data service 120 so that it may then access and decrypt any desired user information, including file locations, and so on.

In scenarios where the client device 105 has previously registered with the data service 120, the device ID and other information may already be stored in the user/device database 145. To authenticate the client device 105, the data service 120 may, in response to receiving the graphic identifiers and login information 220, verify the login information against information associated with the login information, e.g., an account, stored in the user/device database 145. If login is successful, the graphic identifier(s) 110/device ID 400 may then be verified against the graphic identifier(s) 110/device ID 400 stored in the user/device database 145 at 235. As the graphic identifiers are unique to the particular device 105 and are practically impossible to recreate by another device, the graphic identifiers may provide a secure way to register and authenticate a client device 105. Upon registration/authentication, the client device 105 may be granted access to store, retrieve, and otherwise manage user data with the data service 120.

FIG. 2B depicts an example process 200a, which is a variation of process 200, for registering and/or authenticating a second client device 250 with the data service 120. A second client device 250 (e.g., a second device associated with a user of client device 105) may attempt to register with the data service 120, in a similar manner as described above. After submitting login information and graphic identifiers at 220, the data service 120 may verify the login information at 225. The data service 120 may also generate a device ID 400 at operation 230 and attempt to verify the device ID 400/graphic identifiers 110 with information stored in the user/device database 145 at operation 255. In this example, the login information submitted by the second client device 250 may match login information stored in the database, for example that is associated with client device 105. However, the graphic identifier 110 and the device ID 400 of the second client device 250 may not match the graphic identifier 110/device ID 400 associated with client device 105 and hence may not be verified against information stored in the database 125 at operation 255. In this instance, the data service 120 may retrieve or access account/client device 105 information from the user database 145 and obtain one or more communication addresses for the client device 105, which may be indicated as an owner of the associated account. The data service 120 may send a request for verification to the client device 105 at 260. The request for verification may be a simply question, and/or may include one or more other security challenges.

If the client device 105 responds by denying the requested verification at 265, an error message may be transmitted to the second client device 250 by the data service 120. However, if the verification response is affirmative at 265, then the data service 120 may associate and store the graphic identifier/device ID associated with the second client device 250 with the client device 105/account in the user/device database 145 at operation 255

With reference to FIG. 3, an example process 300 for generating a unique graphic identifier or signature 110-a is shown. The unique graphic identifier 110-a may be an example of the graphic identifier 110 described above in reference to FIG. 1. In some aspects, the client device 105 may receive instructions to generate a graphic identifier, for example, to register/authenticate with the data service 120 (e.g., instructions 210). The graphics card, or other graphics generating component (e.g., associated with a client java system) of the client device 105, may, in response, generate a unique graphic identifier 110-a according to process 300. The unique graphic identifier 110 may be uniquely producable by the client device 105 or graphics generation component of the client device 105, such that another device may not be able to reproduce a unique graphic identifier with all of the same graphic characteristics, as will be described below.

The client device 105/graphics generating component of the client device 105 may, as part of generating the unique graphic identifier 110, generate a text graphic 305. The text graphic 305 may include any number of letters, numbers, other characters, or backgrounds and may be associated with one or more characteristics, such as shape, color(s), line weight or other parameters associate with the drawing or generating of a line, shading, or a variety of other graphic effects. The graphics card or other component of the client device 105 may then convert the image of the text graphic to binary 310. The client device 110 may then hash the binary values 310 to decimal or numeric values 315, for example including 8 characters. It should be appreciated that a text graphic component of a graphic identifier 110-a may include any number of characters, for example, based on processing and/or memory capabilities of the client device, number of user of the data system 120, desired level of security, etc.

The client device or graphics card of the client device 105 may also generate an graphic object 320 and, in some cases, apply or draw color or partial color into or around the object 320. In one example, the object 320 may include a circle that is partially or fully colored in, as it is extremely unlikely and/or impossible that two different graphics cards or other graphics components (e.g., of different devices) will generate an identical circle. In other cases, the graphic object may include any two-dimensional shapes or designs (e.g., defining an area or line drawings), any three-dimensional shapes or designs, combinations thereof, etc., which may be associated with one or more characteristics such as color(s), line weight or other parameters associate with the drawing or generating of a line, shading, or a variety of other graphic effects. The image data of the object 320 may then be converted to binary 325 and subsequently hashed to decimal or numeric 330. In some aspects the decimal values 315 of the text graphic may be the same or a difference length as the decimal values 330 of the object. The numeric or decimal values 315 and 330 may then be mathematically combined to form the graphic identifier 110-a. In some aspects, the numeric values 315 and 330 may simply be combined in a string, or may be combined in other ways. As described herein, one graphic identifier 110 may include both the text graphic numeric values 315 and the object numeric values 330, or just one of values 315, 330.

It should be appreciated that the above graphic elements 305 and 320 are only given by way of example. Generally, more detail included in one or more graphic elements that compose a unique graphic identifier 110 will yield a more unique and more difficult to re-create or spoof identifier 110. In some examples, only one graphic element (e.g., including an increased amount of complexity) may be included in the unique graphic identifier 110-a, such as 305, 320, or other graphic element. In other cases, two of the same type of graphic element may be included in the unique graphic identifier, such as two text graphics 305, two object graphics 320, or two other graphic elements, each having one or more unique features or characteristics. In yet some cases, any number of graphic elements may be included in the graphic identifier 110, for example, with the number determined based on processing and/or memory capabilities of the client device 105. In yet some cases, two or more graphic elements, either the same or different, may be graphically combined, with the combined graphic then being converted to numeric form. In this case, the instructions 210 may include instructions or parameters for how to graphically combine different graphic elements. For example, the instructions 210 may include instructions to generate a circle having a color, generate a text graphic having a different color, and combine the two graphic elements by aligning the horizontal center points of each graphic.

In some aspects, a source may be identified in instructions 210 for obtaining a graphic element, such as an image or graphic from a bio scan (e.g., finger, retina, etc.), a picture of an object or person taken by the device, and a variety of other image sources that may be unique to the user of eh client device 105 or the client device 105 itself. In some aspects, the image data from one or more of these sources may be used directly as the unique graphic identifier 110 and/or may be converted by a graphics generation component of the client device 105. In other cases, the instructions 210 may further include instruction for modifying the source graphic or image data in a certain way, such as adding one or more graphic elements as described above, filtering or adjusting the image data in a certain way (color filters, and the like), etc.

In some aspects, the unique graphic identifier 110 may not include or be distinct from a user created signature, for example, that is or mimics a traditional signature (e.g., depiction of the signor's name, stylistic representation or indications of identity, etc.) generated via handwriting with a pen, finger or stylus on a touch pad or touch screen, etc. Such an excluded user-created signature may include the name of the signor written in cursive, stylized depiction of a representation of the signor, artistic depiction of the name of a business or individual with or without added pictorial elements, email signatures or signature blocks, etc.

FIG. 4 depicts an example device identification (ID) 400 that may include one or more graphic signatures or identifiers 110 and other information relating to a client device 105, for example, to be used for registration and/or authentication with data service 120. The device ID 400 may be used in place of or in addition to the graphic identifier(s) 110 of the client device 105. The device ID 400 may be compiled or assembled by the data service 120 based on information received from the client device 105. In the example illustrated, the device ID 400 may include an IP address 405 of the client device 105, a hostname 410 associated with the client device 105, a browser string/operating system (OS) 415 and two graphic signatures or identifiers 420 and 425. In other aspects, the device ID 400 may include a subset of the IP address 405, hostname 410, or browser string 415, and may include the graphic signatures or identifiers 420 and 425. In some examples, other information may be included in addition to or in place of the IP address 405, hostname 410, and browser string 415. In one example, the first signature 420 may include one of numeric values 315 or 330 of FIG. 3, and the second signature may include the other of the numeric values 315 and 330. In some aspects, once the information is compiled by the data service 120, the device ID 400 may be compiled and hashed and subsequently stored, for example, in the user/device database 145 associated with an account/device associated with a user. In some aspects, the user/account information may additionally include login information, such as a user name and password. The device ID 400 may subsequently be retrieved and authenticated against a client device 105 attempting to access the data service 120.

By using a device ID 400 or similar association of client device information including one or more graphic identifiers 420, 425, one or more of the following benefits may be realized. For example, by verifying multiple identifiers/signatures of a client device 105 with registered information, different actions may be configured in response to a subset of the information in the device ID 400 being verified. Alert messaging, for example that is sent to an account owner/primary client device 105 in the event a second client device 250 or an unassociated device submits incorrect identifier information, may be configured based on a number of factors and may be configured by the account owner. For example, in a scenario where the IP address 405 associated with a client device 105 is different from the registered IP address, but the graphic identifiers 420, 425 match, this may indicate that the client device 105 has changed locations, is on a hotspot, or using a dynamic IP address. In this scenario, the client device 105 may be granted access to the data service 120 even though the device is not completely verified. A different host name 410 may indicate that the device's provider has changed, but depending on the IP address 405, may throw a flag causing the data service 120 to ask for re-authentication based on the discrepancy. Different response actions may be configured if, for example, one or more of the signatures 420, 425 are different but the IP address 405, Hostname 410, and/or browser identifier 415 is same. This scenario may indicate a spoofing attempt, may be flagged, and may require re-authentication of the client device 105 or owner of the account. Login information may be similarly adjusted or configured. This may help avoid possible breeches in security as a result of spoofing any one piece of the identification information, which may be done by using Browser or OS 415, IP address 405, and Host information 410. By combining this information and adding two additional complex signature pieces, a much higher level of security may be achieved. In one implementation, the data service 120 may default to generating an error message and restricting access if there is any discrepancy found in any field of the device ID 400. In one example, the data service 120 may prompt the user/client deice 105 to re-authenticate the device if any discrepancy is found.

FIG. 5 depicts an example process 500 for uploading, encrypting, and storing data using the data service 120. The user device 105, after being authenticated by the data service 120, such as according to the techniques described above, may initially upload data 175 to the data service 120 at operation 505. The data may be upload or communicated to the web service over link 115, such as using a Secure Sockets Layer (SSL) encryption process/certificate. The data service 120 may request and obtain one or more system keys and ordered pairs to assembly one or more user keys from the user/device database 145 at 510. The data service 120 may access the system keys and ordered pairs by searching in the user/device database 145 for the device ID, account information, and/or login information associated with the client device 105.

The data service 120 may, and in some cases concurrently with operation 510, request or access and obtain one or more data keys associated with the client device 105 from the key database 150 at operation 515. In some aspects, as described above with reference to FIG. 2A, the data keys may be generated and associated with a client device 105 upon registration. In this scenario, the data service 120 may retrieve the data key(s) from the key database 150, for example, that are associated with the graphic identifier, device ID, or account associated with the client device 105. In some aspects, the data service 120 may generate and encrypt each portion of data (e.g., a file, or other data structure or unit) with a separate data key or data keys. In this scenario, the data service 120 may access one or more data keys already associated with the client device 105 stored in the key database 150. In other cases, the data service 120 may itself generate new data key(s) or request that the key database 150 or associated control aspect of the key database 150 generate new data key(s).

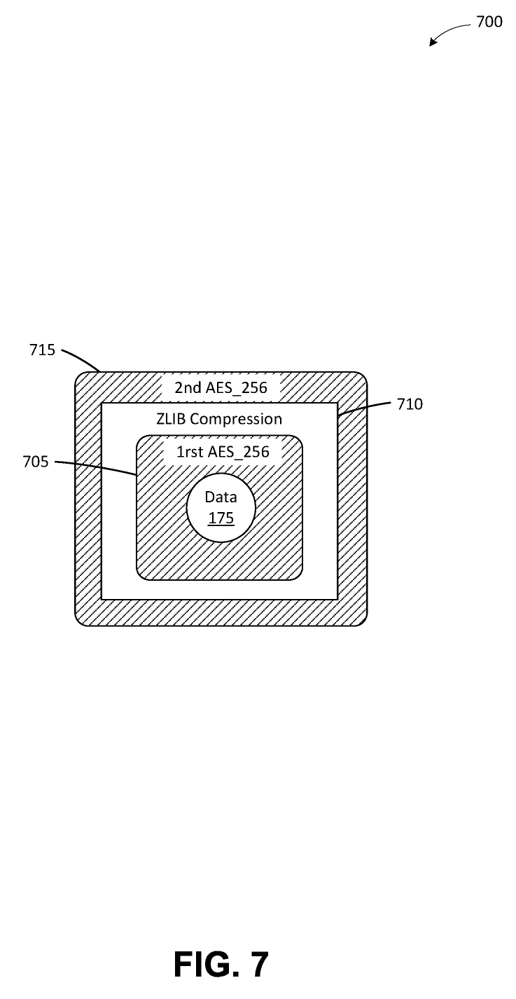

Upon obtaining one or more data keys, the data service 120 may encrypt the data uploaded by the client device 105 via process 520. In one example, the data service 120 may encrypt the data, and then transmit the encrypted data 700 to be stored in the data database 130. An example of the product 700 of the encryption process 520 is depicted in FIG. 7. In one example, the data service 120 may encrypt the data at 525, such as using any of a variety of encryption techniques. The data service 120 may then compress the encrypted data at 530. Subsequent to compression, the data service 120 may perform a second layer of encryption by encrypting the compress encrypted data at operation 535. In some aspects the first encryption and the second encryption processes 525, 535 may be according to the same encryption technique or scheme, such as an Advanced Encryption Standard (AES) technique, such as AES 128, AES 192, AES 256, or other known such processes. In other cases, different encryption techniques may be implemented for each layer of encryption 525, 535. In yet other aspects, more layers of encryption may additionally be added, for example with or without further layers of compression. In some examples, the encrypted data may be compressed using ZLIB or other compression techniques. Once the data service 120 completes the encryption process 520, the double encrypted and compressed data 700 may be stored in the data database 130. The data database 130 may then communicate a stored location or ID associated with the stored data to the data service 120 at 540. The stored location or ID may include a user or client specific database or other data structure and/or one or more file or table locations. The data service 120 may then store and associate the data location or ID with the client device 105/user account, for example, and store the association in the user/device database 145. The data service may additionally provide an indication to the clients device 105 at operation 555 that the data has been successfully uploaded and stored.

The double encrypted and compressed user data 700 may be represented by the user data 175 and a number of layers or wrappers. FIG. 7 depicts the user data 175 surrounded by a first encryption layer 705. According to process 520, the data may first be encrypted using a first encryption process via operation 525, such as AES 256 with one or more unique IV-salts or other random information inserted into the data during encryption, represented by layer 705. Layer 705 may be associated with a first data key, such as a 256 byte key associated with an AES_256 encryption process. Layer or wrapper 710, which surrounds layer 705, may represent a layer of compression, such as produced by ZLIB or other similar types of data compression via operation 530. The encrypted data 705 may be compressed for a number of reasons, including: to reduce the size of the data stored to conserve capacity in the data database 130, and/or to increase the difficulty by which an unwanted party that happens to obtain the encrypted data may decrypt and decipher the data. The compressed and encrypted data 710 may further be encrypted using as second encryption process 535, represented by layer 715. The second encryption process may include AES_256, for example, using a different and unique IV-salt and associated with a 256 byte key, or any other encryption technique, for example, that may be similar or different from the first encryption process. It should be appreciated that encrypted data 700 is given only by way of example and that the disclosure should not be so limited. For example, process 500 may include other encryption techniques for encrypting data at operation 520, including a single encryption process, multiple compression steps, more than two encryption steps, and so on.

Returning back to description of process 500, upon encrypting the data via the first encryption process 525, the data service 120 may encrypt the data key used for the first encryption process with an associated user key at operation 545. The data service 120 may similarly encrypt the second data key associated with the second encryption process 535 with the first user key or a different second user key at operation 545. The encrypted data keys may then be stored in the key database at 550. In some aspects, the user keys may be assembled or generated from the system keys and the ordered pairs obtained from the user/device database 145, according to process 600, which will be described in greater detail below in reference to FIG. 6.

Process 500 may yield an encryption system that is extremely difficult to break with know or projected techniques. As each level of encryption is needed for a subsequent level of encryption (e.g., the data keys are encrypted by user keys, and the user keys must be assembled according to an additional specific and proprietary process), it is extremely difficult for an unwanted party to complete each level of decryption accurately to produce decrypted data. Furthermore, in some aspects, there may be no indication of whether a level of decryption has been completed successfully, making it even more difficult for trial and error type decryption techniques to be successful by unwanted parties, as one flaw may yield unintelligible data. Additionally, each set of encryption keys may be stored in a different location or database, making it even more difficult to obtain the keys if unauthorized. In some aspects, some or all communications between the data service and databases 125, 130, 145, and 150 may be encrypted, further making a security breach very unlikely. In some implementations, the data service 120 may perform most or all operations on data and encryption keys (e.g., encrypting the data, assembling user keys, generating a device ID, decrypting data and data keys, etc.) without storing the data or encryption keys, for example in a separate database or memory. In this way, most or all operations may be performed on streaming data/keys, to further reduce any security breach, and to reduce memory requirements of the data service 120, increase processing speed, improve user experience, etc. In other aspects, at least some of the operations performed by the data service 120 may be performed in conjunction with temporary data storage or memory associated with the data service 120.

FIG. 6 depicts an example process 600 for generating one or more user keys, for example, to be used in encrypting one or more data encryption keys that are then used to encrypt user data stored in a data database 130. In some aspects, one or more user keys may be generated upon registration by a client device 105, and associated with the client device 105/account in the user/device database 145. The user keys may be stored in an un-assembled or un-compiled state, such as a combination of system keys and associated ordered pairs. In this way, any breach of data security of the user/device database 145 will not yield the needed user keys that are operable to decrypt the data keys. The generation of the user keys may include generating a number of system keys and a number of ordered pairs associated with the system keys. After the system keys and the ordered pairs have been generated (e.g., including random values generated by a random number generator), an associated user key may be assembled or compiled via process 625 using the system keys and ordered pairs. In some cases, one or more user keys may be generated or assembled periodically (e.g., every time the client device 105 logins into the data service 120), upon reception of a request to store or retrieve data, randomly, or in response to some other trigger event.

In any of the above implementations, the data service 120 may begin process 600 by requesting system keys and ordered pairs associated with the client device 105 at 605. In response, the user/device database 145 may send the requested system keys and ordered pairs to the data service 120 at 610. In the example illustrated, the client device 105 or data structure may be associated with 6 system keys 625, each of the same or varying lengths (e.g., as illustrated, each being 32 bytes in length) and 6 ordered pairs 630. However, it should be appreciated that any number of system keys 625 and any number of ordered pairs 630 may be used to a similar effect. The system keys 625 and the ordered pairs 630 may be stored in any order, with filler values or without, according to pre-set parameters or upon each generation instance.

Using the obtained system keys 625 and the ordered pairs 630, the data service may assembly one or more user keys according to process 625. In the example illustrated in FIG. 5, two data keys are used to encrypt the user data before it is stored in the data database 130. In this instance, key process 625 may generate 2 separate user keys, with each user key subsequently used to encrypt one of the data keys. In other scenarios, a single user key may be generated and used to encrypt both data keys. Similarly, any number of user keys may be generated to encrypt any number of data keys, for example, based on a desired level of security, processing and/or memory capabilities of the user device 105, servers supporting the data service 120, any of databases 125, 130, 145, or 150, and so on.

For each user key, key process 625 may be performed. Each ordered pair 630 may include two numeric values 665 and 670. Value 665 may include a start byte value and value 670 may include a byte read length value. Each ordered pair 630 may correspond to or be associated with a particular user system key 625. In the example illustrated, the first ordered pair contains the numbers “16” and “10.” The data service 120 may, according to the ordered pair, start at byte 16 of system key 635, and read 10 bytes. These 10 bytes may be temporarily stored and combined with other portions of the remainder of system keys 640-660, according to the remainder of the ordered pairs 630. The output of each operation may be combined (e.g., linearly) at operation 675 into one 32 byte user key. Process 625 may be performed for each desired user key. In some aspects, the same system keys 625, (e.g., keys 635-660) may be used to assembly a single user key, such that another 6 system keys 625 are used to generate a second user key, according to the same or a different set of ordered pairs. In other aspects, one or more system keys 625 may be shared between the two user keys, for example, based on a random selection or other selection criteria. In some aspects, one or more new user keys (e.g., system keys and/or ordered pairs) may be generated upon request by the client device, upon attempted access by an un-registered device, or for a number of other reasons that may be configured by the owner of the associated account/client device 105.

The data service 120 may, concurrently (e.g., simultaneously, or at different times) with generating/assembling the user keys via process 625, access the data keys from the key database 150 at operation 615. In some cases, the data service 120 may generate the data keys in the first instances, and thus not need to retrieve the keys from the key database 150. The data service 120 may use the user keys generated by process 625 to encrypt the data keys, for example using any of various encryption techniques. The encrypted data keys may then be stored in the key database 150 at 620. Process 600 may decrease the likelihood of an unwanted party obtaining one or more user keys, for example, by only generating or assembling the full user keys used to encrypt the data keys upon a request from an authenticated client device 105. Additionally, the fact that the system keys and the ordered pairs may be stored as a string of numeric values may further make a security breach less likely via maintaining the propriety of the user key assembly process or algorithm. The user keys may additionally add another layer of security to the data keys, such that the data keys may only be communicated when encrypted.

It should be appreciated that the lengths of the system keys, ordered pairs, the number of user keys and/or data keys, are all given by way of example, such that other values or lengths are contemplated herein. In addition, the system keys and ordered pairs may be in binary, hex, decimal, and/or include other symbols or characters. For example, the one or more systems keys may be any length between 4 and 1024 bytes, or even larger in some cases. The system key or keys (only 1 key may be used in some implementations) may be the same length or have different lengths.

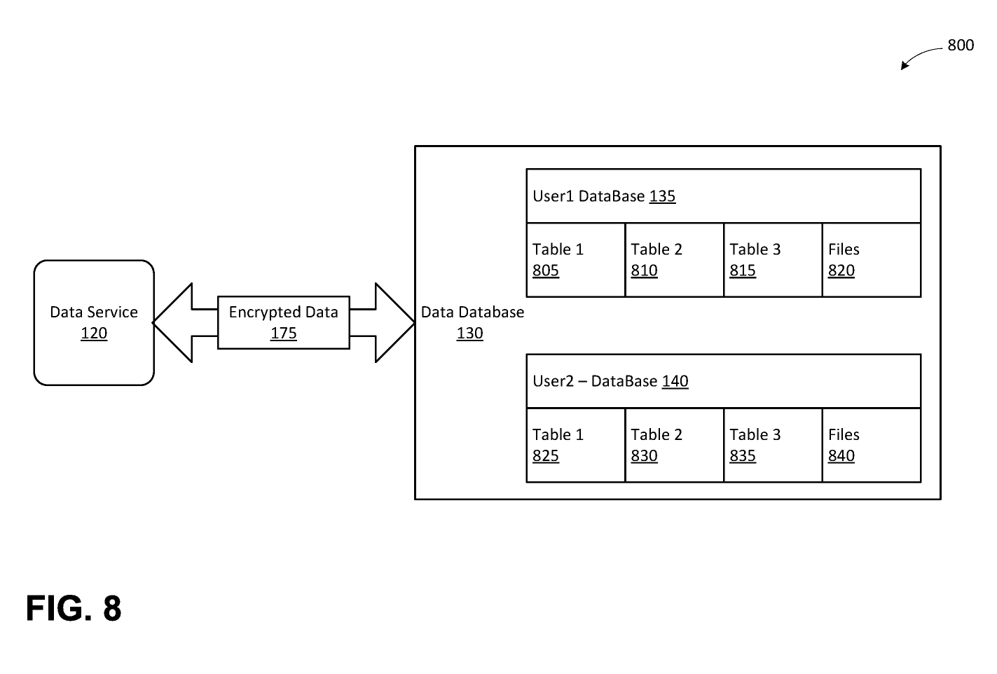

An example organization structure 800 implemented by data database 130 to store user data is illustrated in FIG. 8. After encrypting the user data 175, the data service 120 may send the encrypted data 160, 700 to be stored in the data database 130. In one implementation, each user may be associated with a separate user database or organizational structure 135, 140. In some cases, one or more client devices 105, 250 associated with a user/account may be stored in one database 135, 140. In other cases, each client device 105, 250 may be given its own database 135, 140. In one example, data submitted by a client device 105, 250 may be organized into a file, a folder, or other organizational unit/structure. The client device 105 may provide an interface for organizing data, for example to be stored in different locations, files, folder, etc. In some aspects, the client device 105 may provide an automatic organizational scheme including pre-set folders, etc., for organizing user data, and may enable user customization from the standard scheme. According to the organizational structure determined by the client device 105, user data may be organized and stored into different tables or files 805-820. In this way, data security may be enhanced, albeit at the cost of larger databases, by isolating individual client files. This may further enable storage of larger amounts of data in a single file or table, for example, without comingling data associated with different users or client devices 105. In some aspects, each different table or file 805-820 may be encrypted using a different set of data keys. Additionally or alternatively, each table or file 805-820 may be encrypted according to one or more different data and/or user keys. Upon storing user data in a user database 135, 140, the data database 130 may associate a file location with each portion of data and transmit this location back to the data service 120. The data service may then store the associated file location in the user/device database 145 associated with the client device 105. In some aspects, the data database 130 may encrypt the file location, for example with one or more of the data keys or user keys associated with the data, prior to sending to the data service 120. In other cases, the data database may maintain the file locations and associate them with a data key or client device/device ID/account. In some aspects, the data database 130 may implement its own organizational structure instead of or independent of the organizational structure provided by the client device 105.

FIG. 9 illustrates an example process 900 for decrypting data encrypted by the data service 120 via the techniques described above. After registering/authenticating with the data service 120, for example via the techniques described above, the client device 105 may submit an initial data request, for example, indicating a certain file or files to be accessed, at operation 905 to the data service 120. This may include selecting an option in a web interface to retrieve previously stored data associated with the client device 105. The data service 120 may request and obtain system keys and ordered pairs (e.g., to assemble user keys associated with the client device 105) from the user/device database 145 at operation 910. In some aspects, for example, where the exact file location of the stored encrypted data is stored in the user/device database 145, the data service may request and obtain the file location(s) from the user/device database 145 at operation 915. The data service 120 may also request and obtain the encrypted data from the data database 130 at operation 920 and request and obtain the encrypted data keys from the key database 150 at operation 925. In some examples, operations 910, 920 and/or 925 may be performed concurrently.

Using the obtained system keys and corresponding ordered pairs, the data service 120 may assemble the user keys according to process 625, described above. The data service 120 may then decrypt the encrypted data keys and decrypt the data accessed from the key via process 1000. Process 1000 may include decrypting the encrypted data keys accessed from the key database 150 at operation 935 with the assembled user keys. Once the data service has decrypted at least one of the data keys, the data service 120 may begin to decrypt the encrypted data via process 1000. Once the data service 120 has decrypted at least one of the data keys, the data service 120 may decrypt the double encrypted and compressed data via a second decryption process using the second data key at operation 940. Next, the data service 120 may de-compress the encrypted data at operation 945, and subsequently decrypt the encrypted data at operation 950 using a first data encryption key. Process 1000, which will be described in greater detail below in reference to FIG. 10, may then yield the decrypted data at operation 955. The data service 120 may then communicate or display the decrypted data to the client device 105 to fulfill the initial request at operation 960. In some aspects, including the example described above, most or all of the decrypting may be done by the data service 120, for example to reduce the likelihood of a security breach and/or may be performed on the encrypted data as it is streamed from the data database 130.

FIG. 10 illustrates a more detailed process 1000 for decrypting data encrypted via the techniques described above. After a first user key 1005 has been assembled via process 625 or obtained from the user/device database 145, the key 1005 may be used to decrypt a first encrypted data key 1015, accessed from the key database 150, at operation 1025. Decrypting the first data key 1015 at operation 1025 may include In some aspects, for example when random information (e.g., a salt) is inserted into the data during the encryption process, the random information may be removed in the decryption process. Identification information of the inserted random information may be included or associated with the data key 1010. Similarly, once a second user key 1010 has been assembled or obtained, the second user key 1010 may be used to decrypt a second encrypted data key 1020, also accessed from the key database 150, at operation 1030. Both of the data keys 1015 and 1020 may be encrypted, and hence decrypted, using similar techniques, or may be associated with different encryption/decryption techniques or processes. As generally described herein, each encryption process is assumed to be symmetric. However, a-symmetric keying may be used with minor modification to a similar effect and is contemplated herein.

Once decrypted, the second data key 1020 may be used to decrypt an outer layer 715 of encryption surrounding the data 175 at operation 1035. Operation 1040 may include decrypting the data according to the AES-256 or other standard or protocol. The encrypted and compressed data 710 may then be recovered and subsequently un-compressed, for example using a ZLIB compression/decompression technique or other compression/de-compression techniques. The encrypted data 705 may then be decrypted at operation 1040 using the first data key 1015, for example, also according to an AES_256 protocol, or other protocol. The data 175 may then be recovered. In some aspects, the data keys 1015 and 1020 may be discarded after each use, and new data keys generated and used to re-encrypt the data, for example, when the client device exists or logs out of the data service 120. In this way, security may be further increased.

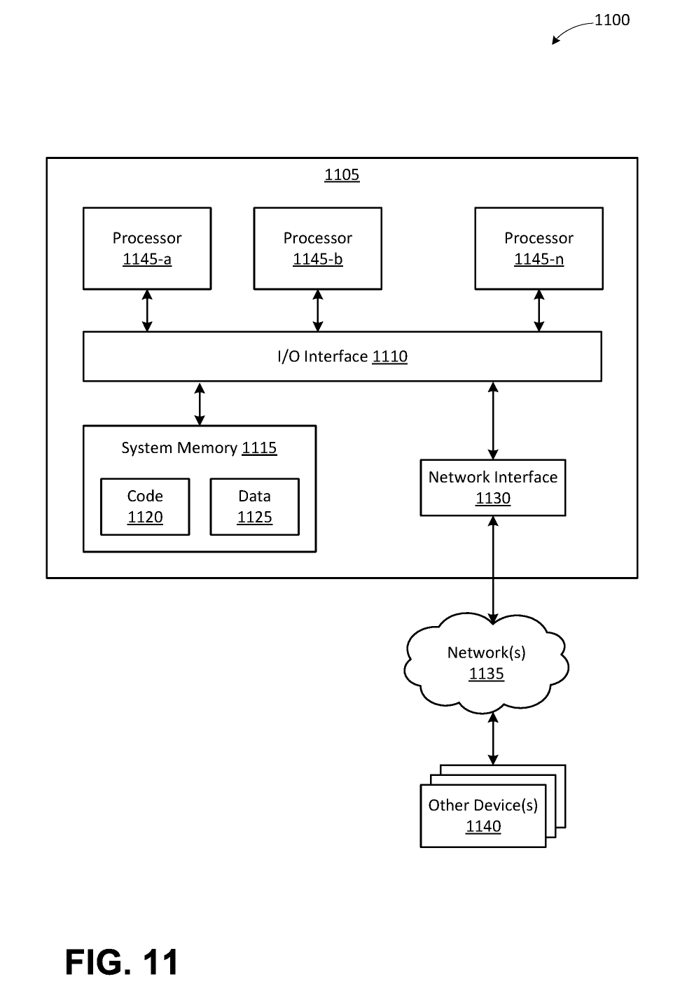

In at least some embodiments, the techniques described herein for securely storing, managing and accessing data may be implemented on one or more computing systems 110, such as including one or more computing devices 1105. FIG. 11 depicts an example of a computer system 1100 including a computing device 1105 in communication with other devices 1140, which may include one or more client devices 105, 250, or databases/database servers 125, 130, 145, and/or 150 previously described, that is configured for providing a data service/web interface 120 and storing data in one or more data stores or databases 125, 130, 145, and/or 150 described herein. In the illustrated embodiment, computing device 1105 includes one or more processors 1005-a, 1005-b through 1005-n coupled to a system memory 1115 via an input/output (I/O) interface 1110. Computing device 1105 further includes a network interface 1130 coupled to the I/O interface 1110, by which computing device 1105 may communicate with other devices 1140. In some aspects, computing device 1105 may be part of or function as one or more servers.

In various embodiments, computing device 1105 may be a uniprocessor system including one processor 1105 or a multiprocessor system including several processors 1105 (e.g., two, four, eight or another suitable number). Processors 1105 may be any suitable processors capable of executing instructions. For example, in various embodiments, processors 1105 may be embedded processors implementing any of a variety of instruction set architectures (ISAs), such as the x106, PowerPC, SPARC or MIPS ISAs or any other suitable ISA. In multiprocessor systems, each of processors 1105 may commonly, but not necessarily, implement the same ISA.

System memory 1115 may be configured to store instructions and data accessible by processor(s) 1105. In various embodiments, system memory 1115 may be implemented using any suitable memory technology, such as static random access memory (SRAM), synchronous dynamic RAM (SDRAM), nonvolatile/Flash®-type memory or any other type of memory. In the illustrated embodiment, program instructions and data implementing one or more desired functions, such as those methods, techniques and data described above, are shown stored within system memory 1115 as code 1120 and data 1125. In some aspects, system memory 1115 may be co-located with other components of the computing device 1105, may be virtual components, or may be physically separated from other components of computing device 1105. In some cases, system memory 1115 may include separate data stores or databases, including databases 125, 130, 145, and/or 150 described above.

In one embodiment, I/O interface 1110 may be configured to coordinate I/O traffic between processor 1105, system memory 1115 and any peripherals in the device, including network interface 1130 or other peripheral interfaces. In some embodiments, I/O interface 1110 may perform any necessary protocol, timing or other data transformations to convert data signals from one component (e.g., system memory 1115) into a format suitable for use by another component (e.g., processor 1105). In some embodiments, I/O interface 1110 may include support for devices attached through various types of peripheral buses, such as a variant of the Peripheral Component Interconnect (PCI) bus standard or the Universal Serial Bus (USB) standard, for example. In some embodiments, the function of I/O interface 1110 may be split into two or more separate components, such as a north bridge and a south bridge, for example. Also, in some embodiments some or all of the functionality of I/O interface 1110, such as an interface to system memory 1115, may be incorporated directly into processor 1105. In some cases, the I/O interface 1110 may include support for multiple input devices including, controllers, keyboards, and the like, and presentation devices including speakers, display devices, etc.

Network interface 1130 may be configured to allow data to be exchanged between computing device 1105 and other device or devices 1140 attached to a network or networks 1135, such as other computer systems or devices, for example. In various embodiments, network interface 1130 may support communication via any suitable wired or wireless general data networks, such as types of Ethernet networks, for example. Additionally, network interface 1130 may support communication via telecommunications/telephony networks such as analog voice networks or digital fiber communications networks, via storage area networks (“SANs”) such as Fibre Channel SANs or via any other suitable type of network and/or protocol, for example, as described above.

In some embodiments, system memory 1115 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media such as magnetic or optical media, e.g., disk or DVD/CD coupled to computing device 1105 via I/O interface 1110. A non-transitory computer-accessible storage medium may also include any volatile or non-volatile media such as RAM (e.g. SDRAM, DDR SDRAM, RDRAM, SRAM, etc.), ROM (read only memory) etc., that may be included in some embodiments of computing device 1100 as system memory 1115 or another type of memory. Further, a computer-accessible medium may include transmission media or signals such as electrical, electromagnetic or digital signals conveyed via a communication medium such as a network and/or a wireless link, such as those that may be implemented via network interface 1130. Portions or all of the computing device 1100 and/or portions or all of other devices 1140 illustrated in FIG. 11 may be used to implement the described functionality in various embodiments; for example, software components running on a variety of different devices and servers may collaborate to provide the functionality. In some embodiments, portions of the described functionality may be implemented using storage devices, network devices or special-purpose computer systems. The term “computing device,” as used herein, refers to at least all these types of devices and is not limited to these types of devices. A computing device or compute node, which may be referred to also as a computing node, may be implemented on a wide variety of computing environments, such as commodity-hardware computers, virtual machines, web services, computing clusters and computing appliances. Any of these computing devices or environments may, for convenience, be described as compute nodes.

Each of the processes, methods, and algorithms described in the preceding sections may be embodied in, and fully or partially automated by, code modules executed by one or more computers or computer processors. The code modules may be stored on any type of non-transitory computer-readable medium or computer storage device, such as hard drives, solid state memory, optical disc, and/or the like. The processes and algorithms may be implemented partially or wholly in application-specific circuitry. The results of the disclosed processes and process steps may be stored, persistently or otherwise, in any type of non-transitory computer storage, such as, e.g., volatile or non-volatile storage.

The various features and processes described above may be used independently of one another, or may be combined in various ways. All possible combinations and sub-combinations are intended to fall within the scope of this disclosure. In addition, certain methods or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The example systems and components described herein may be configured differently than described. For example, elements may be added to, removed from, or rearranged compared to the disclosed example embodiments.

It will also be appreciated that various items are illustrated as being stored in memory or on storage while being used, and that these items or portions thereof may be transferred between memory and other storage devices for purposes of memory management and data integrity. Alternatively, in other embodiments some or all of the software modules and/or systems may execute in memory on another device and communicate with the illustrated computing systems via inter-computer communication. Furthermore, in some embodiments, some or all of the systems and/or modules may be implemented or provided in other ways, such as at least partially in firmware and/or hardware, including, but not limited to, one or more application-specific integrated circuits (“ASICs”), standard integrated circuits, controllers (e.g., by executing appropriate instructions, and including microcontrollers and/or embedded controllers), field-programmable gate arrays (“FPGAs”), complex programmable logic devices (“CPLDs”), etc. Some or all of the modules, systems, and data structures may also be stored (e.g., as software instructions or structured data) on a computer-readable medium, such as a hard disk, a memory, a network, or a portable media article to be read by an appropriate device or via an appropriate connection. The systems, modules, and data structures may also be transmitted as generated data signals (e.g., as part of a carrier wave or other analog or digital propagated signal) on a variety of computer-readable transmission media, including wireless-based and wired/cable-based media, and may take a variety of forms (e.g., as part of a single or multiplexed analog signal, or as multiple discrete digital packets or frames). Such computer program products may also take other forms in other embodiments. Accordingly, the present invention may be practiced with other computer system configurations.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While certain example embodiments have been described, these embodiments have been presented by way of example only, and are not intended to limit the scope of the aspects disclosed herein. Thus, nothing in the foregoing description is intended to imply that any particular feature, characteristic, step, component, or block is necessary or indispensable. Indeed, the novel methods and systems described herein may be embodied in a variety of other forms; furthermore, various omissions, substitutions, and changes in the form of the methods and systems described herein may be made without departing from the spirit of this disclosure. The accompanying claims and their equivalents are intended to cover such forms or modifications as would fall within the scope and spirit of certain aspects disclosed herein.

What is claimed:

1. A method of controlling access to data via multiple encryption keys by a data service, the method comprising:
encrypting user data with a first data key and a second data key and storing the encrypted user data in a data database;
encrypting the first data key with a first user key;
encrypting the second data key with a second user key;
storing the first data key and the second data key and the first user key and the second user key in separate locations; and
associating the first user key and the second user key with a client device.

2. The method of claim 1, wherein the first user key comprises a first string of a plurality of ordered pairs, wherein each of the plurality of first order pairs corresponds to one of a plurality of first systems keys, and wherein each of the plurality of first ordered pairs comprises a first start value and a first read length value relative to one of the plurality of first system keys.

3. The method of claim 2, wherein the second user key comprises a second string of a plurality of ordered pairs, wherein each of the plurality of second order pairs corresponds to one of a plurality of second systems keys, and wherein each of the plurality of second ordered pairs comprises a second start value and a second read length value relative to one of the plurality of second system keys.

4. The method of claim 3, wherein the first start value, the second start value, the first read length value, and the second read length value each comprise byte values.

5. The method of claim 3, wherein the first string of plurality of ordered pairs contains only numeric values representing the plurality of first ordered pairs, and wherein the second string of plurality of ordered pairs contains only numeric values representing the plurality of second ordered pairs.

6. The method of claim 3, wherein the first set of the plurality of system keys comprises the second set of the plurality of system keys.

7. The method of claim 3, wherein the first user key comprises a first string of six ordered pairs, wherein each of the six first order pairs corresponds to one of six first systems keys, wherein the second user key comprises: a second string of six ordered pairs, wherein each of the six second order pairs corresponds to one of six second systems keys.

8. The method of claim 1, wherein the first data key and the second data key are stored in a key database, and wherein the first user key and the second user key are stored in a user database separate from the key database.

9. The method of claim 8, wherein the client device is associated with a device ID, and wherein the device ID is stored in the user database.

10. The method of claim 1, further comprising:
receiving a request, from the client device, to access the user data; and
upon verification of the client device, decrypting and retrieving the user data in response to the request, the decrypting comprising:
accessing the first user key and the second user key;
retrieving the encrypted user data from the data database;
accessing the first data key and the second data key;
decrypting the first data key and the second data key using the first user key and the second user key; and
decrypting the user data with the decrypted first data key and the decrypted second data key.

11. The method of claim 10, wherein at least two of accessing the first user key and the second user key, retrieving the encrypted user data, and accessing the first data key and the second data key are performed concurrently.
